(19) United States
(12) Patent Application Publication
(10) Pub. No.: US 2025/0071865 A1
(43) Pub. Date: Feb. 27, 2025

(54) DOMESTIC APPLIANCE AND PULL-OUT GUIDE FOR A DOMESTIC APPLIANCE

(71) Applicant: PAUL HETTICH GMBH & CO. KG, Kirchlengern (DE)

(72) Inventors: Peter JÄHRLING, Bünde (DE); Andreas LÖH, Kirchlengern (DE); Johann-Sebastian LESSMANN, Löhne (DE); Thomas BECKMANN, Paderborn-Sande (DE)

(21) Appl. No.: 18/729,569

(22) PCT Filed: Jan. 17, 2023
(86) PCT No.: PCT/EP2023/051013

§ 371 Date: Jul. 17, 2024

(30) Foreign Application Priority Data
Jan. 18, 2022 (DE) 10 2022 101 096.1

(51) Int. Cl. H05B 6/64; F24C 15/16

(52) U.S. Cl. CPC H05B 6/6408; F24C 15/168

(57) ABSTRACT

A pull-out guide for a domestic appliance with microwave cooking function includes a cabinet rail and at least one metal running rail movable relative thereto, to support a carrier. St least one support element for the carrier is secured to the running rail and is made, at least in part, of an electrically insulating material. In a front region of the running rail, as seen in the pull-out direction, a stopper is arranged, which has a support portion, as support element for the carrier, oriented parallel to the pull-out direction and protruding upwardly above the running rail.

### BACKGROUND AND SUMMARY OF THE INVENTION

Exemplary embodiments of the invention relate to a pull-out guide for a domestic appliance with a microwave cooking function, which has a cabinet rail and at least one metallic running rail movable relative thereto for supporting a carrier, wherein at least one support element is arranged on the running rail and is made at least partially from an electrically insulating material. The invention also relates to a domestic appliance with microwave cooking function with such a pull-out guide.

In various types of domestic appliances, pull-out guides have become established on which removable supports can be placed, which can be conveniently inserted into the domestic appliance or extended and removed more easily using the pull-out guide. In the case of cooking appliances, such supports are, for example, food carriers such as baking trays or grids. In other domestic appliances, for example food warmers or refrigerators, the supports can also be baskets, trays, or other food containers.

As a rule, both the running rails of the pull-out guides and the supports are made of a metallic material. The arrangement of metal on metal is electrically conductive and also conducts heat well, which can be problematic in cooking appliances and especially in microwave ovens. Electrical contact between the pull-out guide and a generally conductive coated front panel of a microwave oven is also unfavorable with regard to possible sparking. In addition, the combination of a metal support on a metal running rail leads to increased noise generation, e.g., when placing or during vibrations which can be caused by drive motors, fans or similar.

To prevent electrical contact in microwave cooking appliances, it is known to provide the food carriers and/or the running rails of the pull-out guide with an electrically insulating coating, for example a ceramic coating. However, such a coating is susceptible to scratching and does not reduce noise.

A pull-out guide for a cooking appliance that is at least partially coated with PTFE (polytetrafluoroethylene) is known from the publication DE 102 11 470 A1.

The pull-out guide is easier to clean thanks to the coating and there are advantages with regard to the smooth running of the pull-out system, as this coating also dampens noise.

The publication DE 10 2017 202 746 A1 describes a pull-out guide for a cooking appliance in which a contact surface between a running rail and a support is reduced by a support element. For this purpose, a narrow, strip-shaped support element is arranged essentially continuously lengthwise on the running rail, which is thus positioned between the running rail and the support. The support element can be made of plastic, which results in good sliding properties and noise damping. Plastic as a material also has an insulating effect. The support element can, for example, be inserted into a groove-shaped receptacle that is formed in the longitudinal direction of the running rail.

Exemplary embodiments of the present invention are directed to a pull-out guide for a domestic appliance with microwave cooking function and a domestic appliance equipped therewith, in which electrical insulation between the running rail and the support can be achieved in a simple and durable manner.

A pull-out guide of the type mentioned at the beginning is characterized in that a stopper is arranged in a front region of the running rail as seen in the pull-out direction, which has a support portion, as a support element for the carrier, oriented parallel to the pull-out direction and protruding upwardly above the running rail.

A stopper, which is inserted into the running rail from the front, e.g., pushed in, is often used to close off the running rail at the front and thus prevent the risk of injury and provide a front stop for the carrier. In accordance with the invention, the stopper is now provided with a support portion that is oriented parallel to the pull-out direction and protrudes upwardly above the running rail and which forms the support element for the carrier.

Assuming that a stopper is usually present anyway, electrical and optionally thermal insulation between the carrier and the metal running rail is achieved in this way, at least in the front region of the running rail, without an additional element. It is noted that a stopper in the sense of the application is an element that can be pushed into the running rail from the front or that can be pushed onto the running rail from the front.

The section of the stopper that serves as a support element is made of an insulating material that is electrically insulating and, optionally, also thermally insulating and/or shock-insulating. The stopper can also be made as a whole from the insulating material. The support portion of the stopper can, for example, have longitudinal webs on which the carrier can rest. The electrically insulating materials listed below can be used, among others: Ceramics, high-temperature-resistant thermoplastics, in particular from the polyether ketone family (e.g. polyether ether ketone-PEEK) and/or elastomers, in particular from the polysiloxane or thermoset family.

In an advantageous design of the pull-out guide, the stopper also has a support plate for the carrier that protrudes forwards and upwards over the running rail. As a result, the stopper serves as a front stop for the carrier. An upwardly projecting guide pin for the carrier can also be arranged in the area of the support portion of the stopper. If the guide pin engages in a corresponding recess or indentation in the carrier, the carrier is also fixed laterally and/or in the pull-out direction.

In a further advantageous design, the pull-out guide has a stop element that is mounted on the running rail in a rear area as seen in the pull-out direction and has a stop for the support that protrudes upwardly above the running rail. Preferably, the stop element has a further support portion for the carrier that is oriented parallel to the direction of extension and protrudes upwardly above the running rail. As a result, the carrier rests on the support portion of the stopper in the front region and on the further support portion of the stop element in the rear area. If the support portion of the stopper and the further support portion are of the same thickness, the support is oriented parallel to the running rail. Alternatively, it is possible to form the two support portions in defined and optionally significantly different thicknesses. In this case, an inclination of the pull-out guide can be provided, even if the support is aligned flat, which prevents or promotes the pull-out guide to run in/out on its own, for example, without tilting the support. Preferably, the stop element as a whole or at least the further support portion is made of an insulating material, so that the support is then completely electrically insulated from the running rail.

Furthermore, the stop can be formed by a protrusion with which the stop element is placed on a stop bolt that is arranged on the running rail. Such stop bolts are often fitted as standard to running rails and can then be used advantageously as a fastening option for the stop element. A damping cap made of a material that is softer than the material of the protrusion can also be placed on the protrusion. This results in a noise-damped stop and soft positioning of the carrier.

In a further advantageous design, the pull-out guide has at least one further support element that is mounted on the running rail and has a further support portion for the carrier that is oriented parallel to the pull-out direction and protrudes upwardly above the running rail. The further support element can have a C-shaped base body so that it can be simply clipped onto the running rail for installation. A further support point for the carrier (in addition to the stopper) can also be provided in this way by the support element, which does not represent a rear stop for the carrier, but supports the carrier in a central area of the running rail, for example. Like the support portion of the stopper, the other support portions can also be provided with longitudinal webs or an upwardly projecting guide pin for the carrier can be arranged in the region of the support portions.

A domestic appliance with microwave cooking function according to the invention is characterized in that it has at least one such pull-out guide. This results in the advantages mentioned in connection with the pull-out guide.

### BRIEF DESCRIPTION OF THE DRAWING FIGURES

The invention is explained in more detail below with reference to exemplary embodiments with the aid of figures, wherein:

FIG. 1a shows an isometric representation of a pull-out guide with support elements;

FIG. 1b shows the pull-out guide in FIG. 1a with dismantled support elements;

FIG. 1c shows a representation of the pull-out guide in FIGS. 1a, b with the baking tray in place;

FIG. 2a shows an isometric representation of a pull-out guide in a further exemplary embodiment with dismantled support elements and a section of a baking tray to be placed on top;

FIG. 2b shows pull-out guides as shown in FIG. 2a with baking tray in place;

FIG. 2c shows a detailed representation from FIG. 2b;

FIGS. 3a, b show a pull-out guide in a further exemplary embodiment with dismantled support elements (FIG. 3a) and assembled with the baking tray in place (FIG. 3b);

FIGS. 4a, b show two isometric detailed representations of a support element for a pull-out guide;

FIG. 4c shows a stopper;

FIG. 5a shows various isometric representations of an additional support element for a pull-out guide;

FIG. 5b shows a sequence of sectional drawings showing the positioning of the additional support element according to FIG. 5a on a pull-out guide;

FIG. 6a shows a sectional view of a pull-out guide with a further example of an additional support element and an overlying baking tray;

FIG. 6b shows two different isometric representations of the additional support element according to FIG. 6a; and

FIG. 6c shows a sequence of two isometric representations in each case, which show a placement of the additional support element according to FIGS. 6a, b on a section of a pull-out guide.

In all figures, the same reference signs indicate elements that are identical or have the same effect. For reasons of clarity, not all elements are marked with reference signs in all figures. If relative terms such as “left” or “right” are used in the description, these refer to the figures described. Only the terms “front”, “rear”, “top” and “bottom” refer to the natural orientation of the pull-out guide in operation, in which a support rests on top of the pull-out guide and in which the front end of the pull-out guide faces towards a user located in front of the domestic appliance in which the pull-out guide is used.

### DETAILED DESCRIPTION

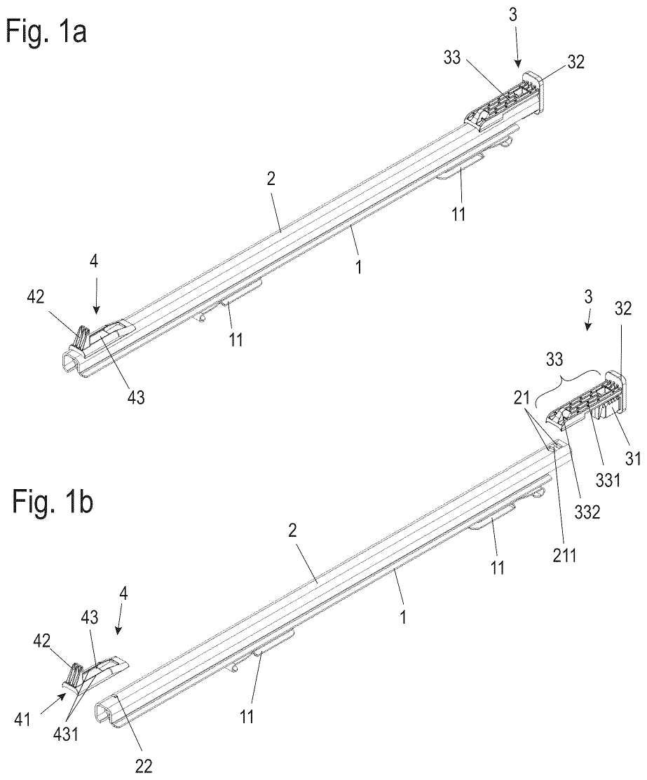

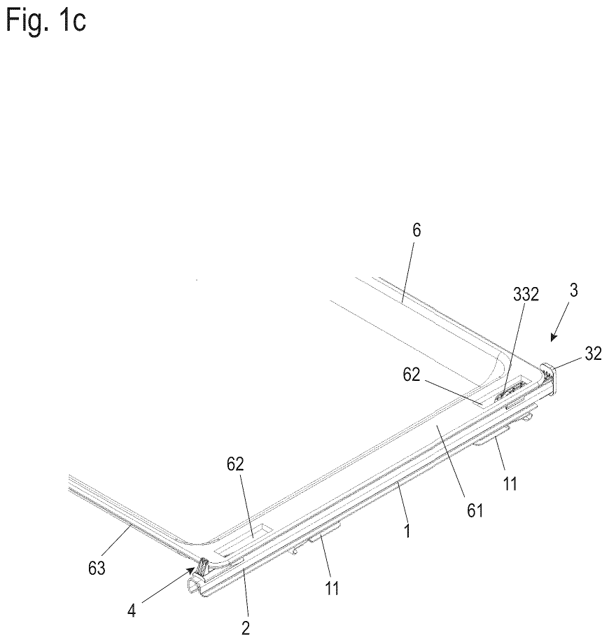

FIGS. 1a-1c show a first exemplary embodiment of a pull-out guide according to the application.

The pull-out guide has a fixed cabinet rail 1 that can be fixed in or on a domestic appliance using mounting elements, here exemplified by mounting clamps 11. The pull-out guide 1 is suitable for a cooking appliance with a food carrier, e.g., a baking tray 6 (see FIG. 1c). In this case, the mounting clamps 11 can be attached to a side grid, which is typically located in the cooking chamber of the cooking appliance.

The pull-out guide comprises a running rail 2, which is mounted so that it can move relative to the cabinet rail 1. In the example shown, the cabinet rail 1 as well as the running rail 2 and the mounting clamps 11 are made of metal, e.g., punched and bent sheet metal. Between cabinet rail 1 and running rail 2 there is an arrangement of rolling elements, not visible here, which allow the running rail 2 to move easily in relation to the cabinet rail 1. Further components, such as additional running rails or center rails, can also be arranged between the cabinet rail 1 and the running rail 2 to enable an extension of the pull-out guide.

FIG. 1a shows the pull-out guide in an assembled state with a stopper 3 and a stop element 4. In FIG. 1b, the stopper 3 and the stop element 4 are shown separately from the pull-out guide. Finally, FIG. 1c shows the pull-out guide in an assembled state with the baking tray 6 in place.

The stopper 3 is fixed to a front end of the running rail 2. For this purpose, it has an insertion body 31, which is pushed into the essentially U-shaped profile of the running rail 2. After the insertion body 31 has been pushed in, the stopper 3 rests against the front end of the running rail 2 with a contact plate 32 projecting laterally and in particular upwards beyond the insertion body 31. The contact plate 32 prevents the baking tray 6 from slipping forwards off the running rail 2.

In the front region of the running rail 2, two recesses 21 are made in the material of the running rail 2, into which, for example, latching elements of the insertion body 31 engage, so that the stopper 3 is fixed to the running rail 2 after insertion. However, it is also possible to secure the inserted stopper 3 to the running rail by embossing a web 211 remaining between the two recesses 21.

A special feature of the stopper 3 is a support portion 33 which, starting from the contact plate 32, rests on the running rail 2 when the stopper 3 is inserted. Towards the running rail 2, the support portion 33 is adapted to the shape of the running rail 2 and embraces it at least partially (in the present case in the area of lateral chamfers of the running rail 2) in order to be fixed laterally on the running rail 2 and to achieve a larger support surface for the baking tray 6. Towards the top, the support portion 33 is provided with longitudinal webs 331. In addition, a guide pin 332 projects in height beyond the longitudinal webs 331.

A stop element 4 is placed on the rear end of the running rail 2, which provides an upwardly projecting stop 42 and a further support portion 43. The stop element 4 is provided with a hole 22 for fastening it to the running rail 2. The stop element 4 has a mounting means 41, for example a pin, hook, or lug not visible here, which engages in the hole 22 and which can be provided with latching means so that the stop element 4 is held on the running rail 2. Instead of a pin, a screw connection can also be used to secure the stop element or a rivet that engages in the hole 22. In this case, the screw head or rivet head are housed in a recess in the stop element 4 in order to be at a distance from the baking tray 6, so that the insulation between the baking tray 6 and the running rail 2 is maintained.

A profiling of the underside of the stop element 4, which is adapted to the shape of the running rail 2, also serves to secure the stop element 4 to the running rail 2. This profiling, in particular regions that partially enclose the sides of the running rail 2, is also to be understood as a mounting means 41. The further support portion 43 is provided with longitudinal webs 431 in a similar way to the support portion 33 of the stopper 3.

As can be seen in FIG. 1c, the baking tray 6 rests with an edge 61 on the support portions 33 and 43 and in particular on the longitudinal webs 331 and 431. In contrast to the running rail 2, which is made of metal, the stopper 3 and the stop element 4 are made of an electrically insulating material, for example the plastic PEEK (polyether ether ketone), so that the baking tray 6 placed on it is electrically insulated from the metal of the pull-out guide. In addition, the stopper 3 separates the metal of the running rail 2 from a door or flap of the microwave oven through the contact plate 32, thus preventing the otherwise possible formation of sparks between the front end of the running rail 2 and the door or flap. Microwave ovens often use a door or flap with a front panel that is provided with conductive elements, for example with a conductive coating or wires in the glass.

The stopper 3 and the stop element 4 can also have a noise-damping effect. In order to optimize noise damping, parts of the stopper 3 and/or the stop element 4 can also be made of a softer component than the base material. For example, the longitudinal webs 331 or 431 can be made of a molded-on or bonded-on, softer silicone material.

The baking tray 6 has apertures 62 in the edge 61, wherein the guide pin 332 of the stopper 3 engages in the front of the apertures 62 and thus positions the baking tray 6 during placement and, in particular, fixes it in a lateral direction. In the rear region of the baking tray 6, it rests with an outer edge 63 against the stop 42 of the stop element 4. Alternatively, the carrier can also be positioned on the elements of the stopper 3 and/or the stop element 4 on the running rail 2 by means of a flanged edge of the carrier, in this case the baking tray 6, or a circumferential wire of a lattice-shaped carrier.

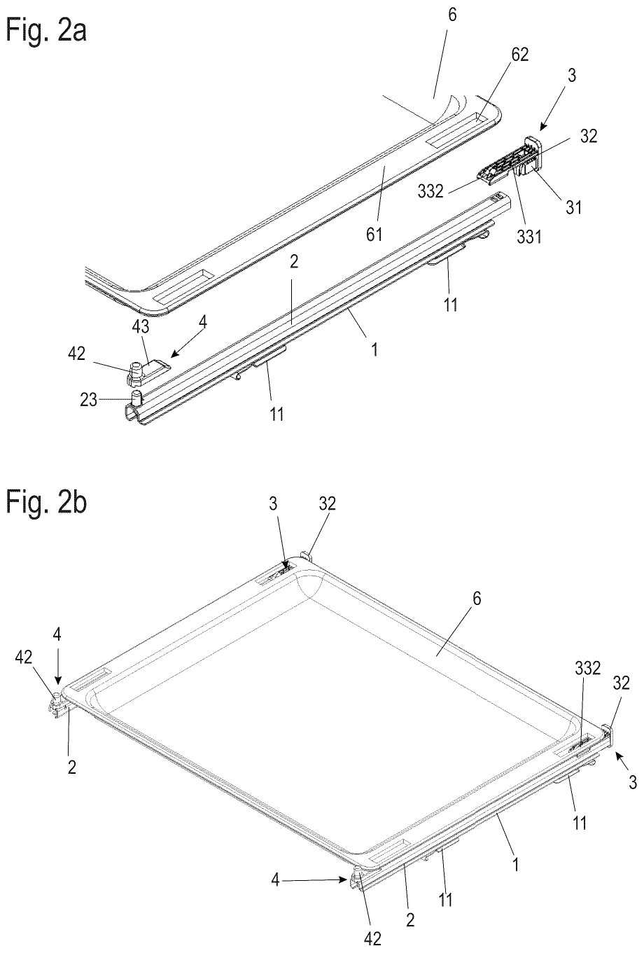

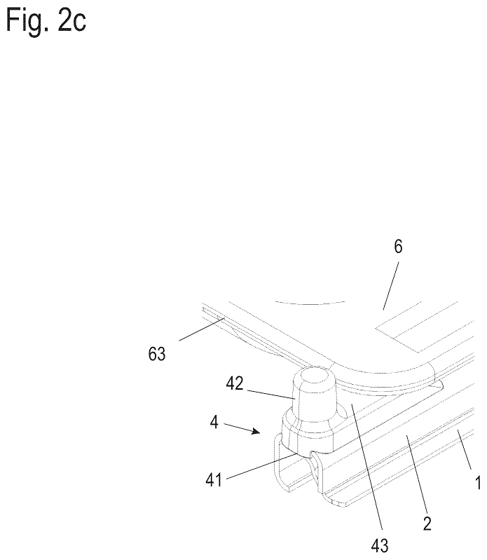

FIGS. 2a-c show a further exemplary embodiment of a pull-out guide according to the application. This pull-out guide also has a stopper 3 and a stop element 4. FIG. 2a shows the pull-out guide with the stopper 3 and stop element 4 removed and a baking tray 6 in place. FIG. 2b shows the baking tray 6 placed on the two pull-out guides shown here. FIG. 2c is a detailed representation of the rear support region of the baking tray 6 on the pull-out guide.

The structure of the pull-out guide of this second exemplary embodiment with cabinet rail 1 and running rail 2 is basically comparable to that of the first exemplary embodiment. In contrast to the first exemplary embodiment, there is no hole at the rear end of the running rail 2 for fastening the stop element 4, but a metal stop bolt 23 is fastened, in particular welded, to the running rail 2.

The stopper 3 fixed at the front end of the running rail 2 corresponds to that of the first exemplary embodiment, the description of which is hereby referred to. The stop element 4, which is inserted in the rear area of the running rail 2, differs from that of the first exemplary embodiment. It also has a support portion 43, on which the baking tray 6 is positioned with its edge 61. Behind the support portion 43, a stop 42 is formed, which here has the shape of a hollow cylindrical protrusion that forms a cap with which the stop element 4 is placed on the stop bolt 23 of the running rail 2. The stop element 4 can be attached to the stop bolt 23 by positive or frictional locking. In addition, at the rear end of the stop element 4, a latching element engaging around the edge of the running rail 2 can be formed as a mounting means 41.

Like the stopper 3 and the stop element 4 of the first exemplary embodiment, the stop element 4 of the second exemplary embodiment can be made of an insulating material, for example PEEK. It is also conceivable that a softer material, for example silicone, is used in the area of the support 43. As in the first exemplary embodiment, the support of the baking tray 6 on the support portion 33 or 43 of the stopper 3 or stop element 4 provides electrical, or optionally also thermal or noise-damping insulation between the baking tray 6 and the running rail 2 and, through the contact plate 32, between the running rail 2 and a door, flap or front panel of the domestic appliance.

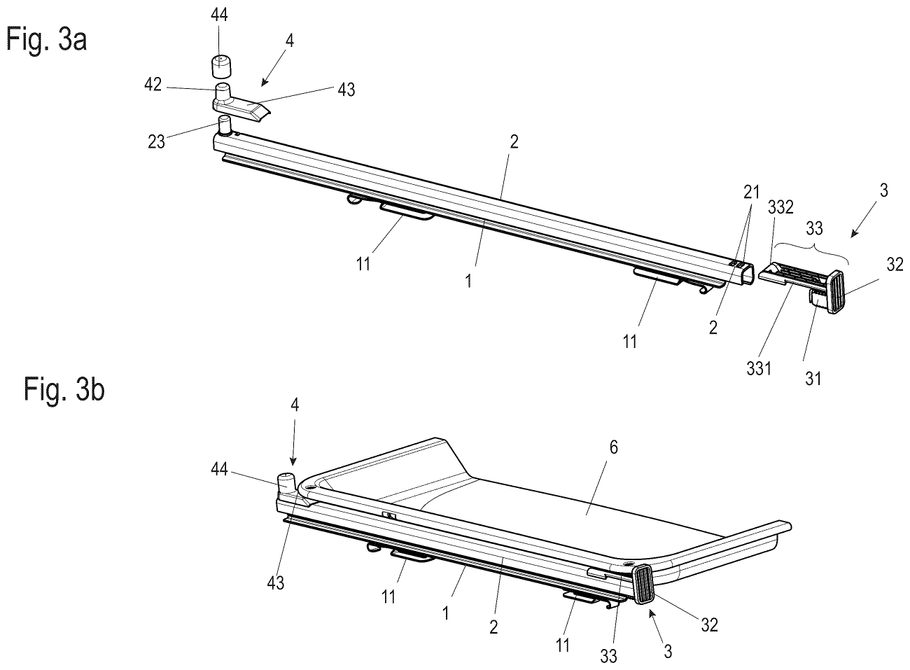

FIGS. 3a and 3b show a further development of the second exemplary embodiment. The basic structure of the pull-out guide corresponds to that of the second exemplary embodiment shown in FIGS. 2a-c. FIG. 3a shows the pull-out guide with the stopper 3 removed and the stop element 4 lifted off. FIG. 3b shows the assembled pull-out guide with the baking tray 6 in place.

In this third exemplary embodiment, the stopper 3 again corresponds to that of the exemplary embodiments described above. The stop element 4 is constructed in a similar way to that of the second exemplary embodiment. Here too, the stop element 4 is provided with a hollow cylindrical protrusion which forms a cap with which the stop element 4 is fitted onto the stop bolt 23 of the running rail 2. In addition, a damping cap 44 is provided, which is placed on the stop 42 of the stop element 4. This damping cap 44 is preferably made of a softer material, for example a silicone, so that an impact of the backing plate 6 against the stop element 4 is damped even more effectively.

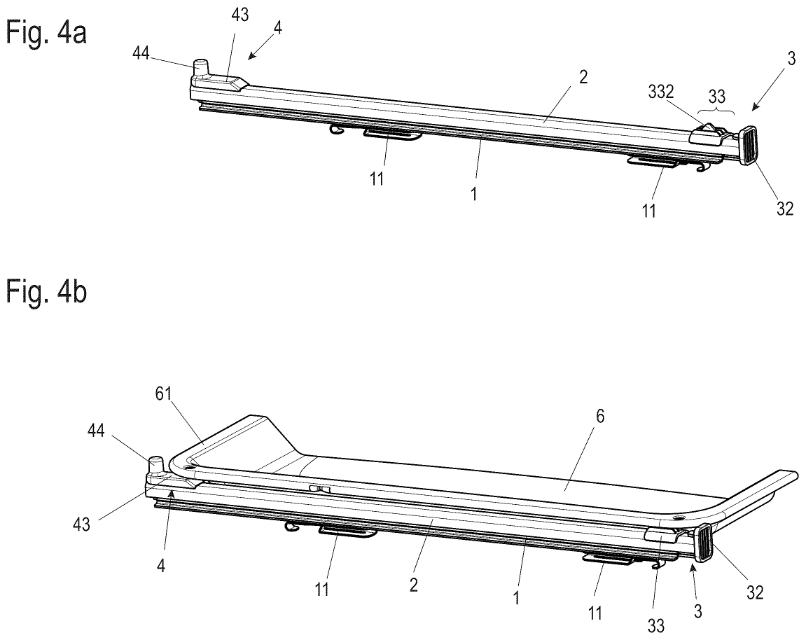

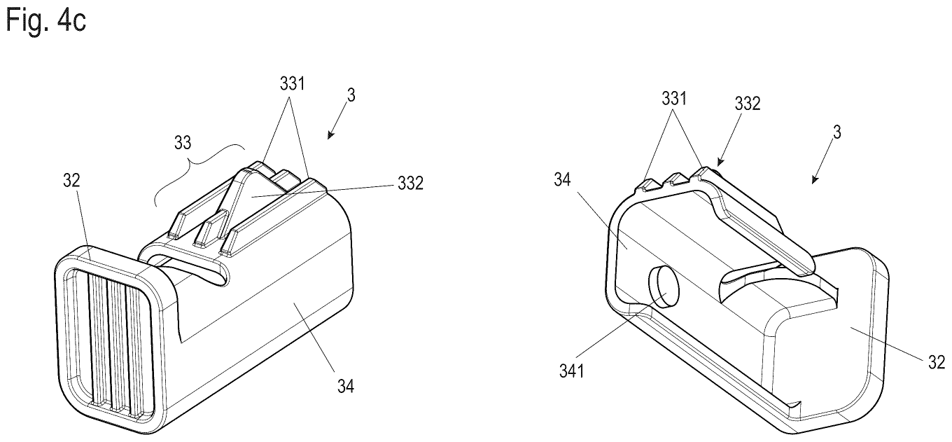

FIGS. 4a-c show a further exemplary embodiment of a pull-out guide according to the application with a stopper 3. FIGS. 4a, b show the assembled pull-out guide in an isometric overall view, once without the baking tray (FIG. 4a) and once with the baking tray 6 in place (FIG. 4b).

The basic structure of the pull-out guide with cabinet rail 1 and running rail 2 corresponds to the structure of the pull-out guides shown above.

A stop element 4, which is already shown in this design in the third exemplary embodiment in FIGS. 3a and 3b, is used in the rear area of the running rail 2.

In FIG. 4c, the stopper 3 according to FIGS. 4a, b is shown separately and in detail in two isometric views from different angles.

Unlike the stopper 3 described in the first two exemplary embodiments, this stopper 3 as shown in FIGS. 4a-c is not inserted into the front end of the running rail 2, but is pushed onto the front end.

For this purpose, the stopper 3 has an approximately C-shaped base body 34, which at least partially surrounds the running rail 2. The base body 34 can be made of an elastic material to the extent that it can also be clipped around the running rail 2 from the side.

A projection 341 is arranged on an inner side of the base body 34, which engages in a corresponding recess or hole on the running rail 2, whereby the stopper 3 is fixed in the longitudinal direction. However, the form-fit fixing and the projection 341 provided for this purpose can also be dispensed with if the stopper 3 and the running rail 2 are adapted to each other in such a way that the stopper 3 is fixed by frictional engagement.

On the outer upper side of the base body 34, a support portion 33 is again formed for an edge of a placed baking tray. Similar to the stopper 3 shown in FIGS. 1a-3b, longitudinal webs 331 and a guide pin 332 are formed, which positions and laterally fixes the placed baking tray.

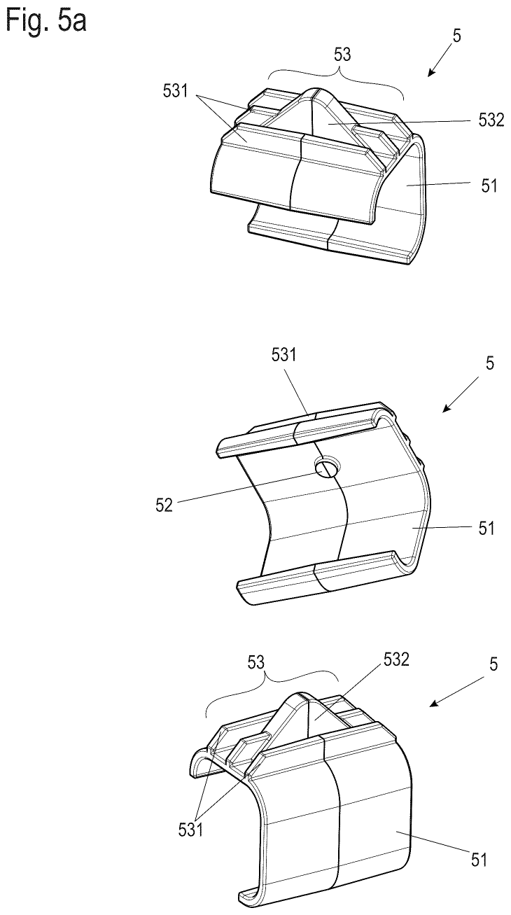

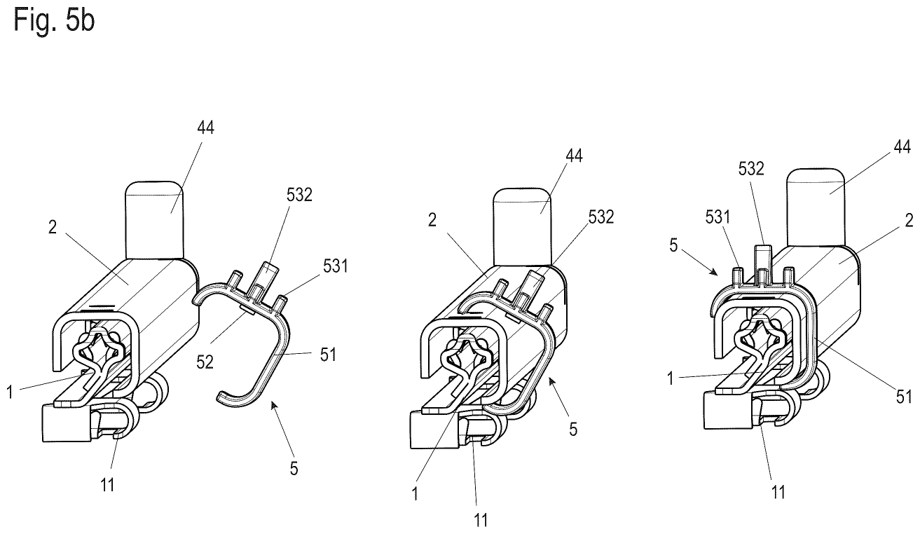

FIGS. 5a, b show an additional support element 5 that can be used together with the previously shown stopper 3 in a pull-out guide according to the application. This additional support element 5 is shown separately in FIG. 5a in isometric representations from three different viewing directions. FIG. 5b shows a mounting process of the additional support element 5 in three sequences using sectional views of a pull-out guide 2.

The additional support element 5 has an approximately C-shaped base body 51 with which it is clipped around the running rail 2. The base body 51 is made of an elastic material that allows this clip-on movement.

A projection 52 is arranged on the upper inner side of the base body 51, which engages in a corresponding recess or hole on the running rail 2 after clipping on, whereby the additional support element 5 is fixed in the longitudinal direction. However, it is also possible to dispense with the form-fit fixing and the projection 52 provided for this purpose, so that the additional support element 5 can be placed freely on the running rail 2 depending on the shape of the attachable support, in this case the baking tray 6, and maintains its position in the direction of the pull-out guide solely by frictional engagement.

A projection 52 is arranged on the upper inside of the base body 51, which engages in a corresponding recess or hole on the running rail 2 after clipping on, whereby the additional support element 5 is fixed in the longitudinal direction. However, it is also possible to use the form-fit

The additional support element 5 can be freely positioned on the running rail 2 depending on the shape of the support, in this case the baking tray 6, and maintains its position in the direction of the pull-out guide solely by frictional engagement.

The outer upper side of the base body 51 forms a further support portion 53 for an edge of a baking tray placed on top. Similar to the support portion 33 of the stopper 3 (see FIGS. 1-4), longitudinal webs 531 and a guide pin 532 are formed, which positions and laterally fixes the placed baking tray.

It should be noted that one or more such additional support elements 5 can be arranged on the running rail 2, in particular an additional support element 5 in the region of the rear end of the running rail 2, i.e., adjacent to a damping cap 44, which here, as shown in FIG. 5b, is placed directly on a stop bolt of the running rail 2. In such a design of the pull-out guide, the baking tray is aligned parallel to the running rail 2 and is also electrically insulated from it.

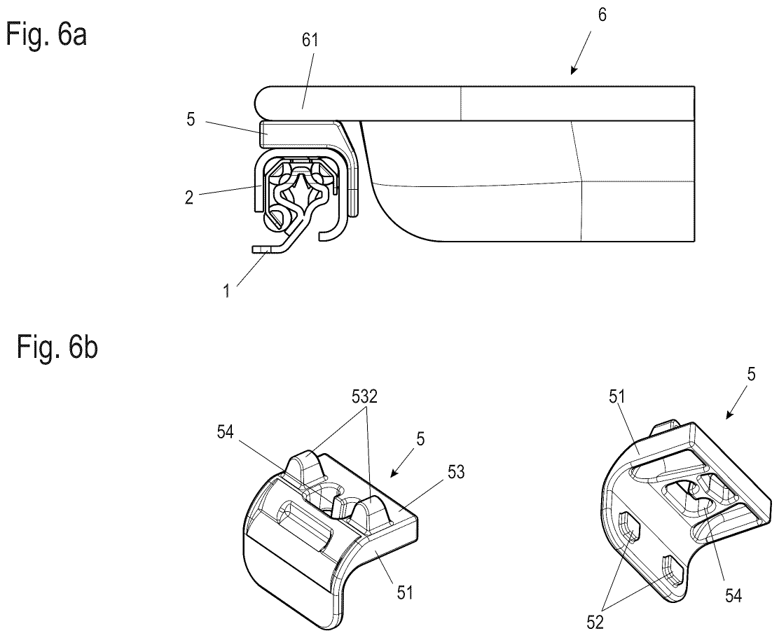

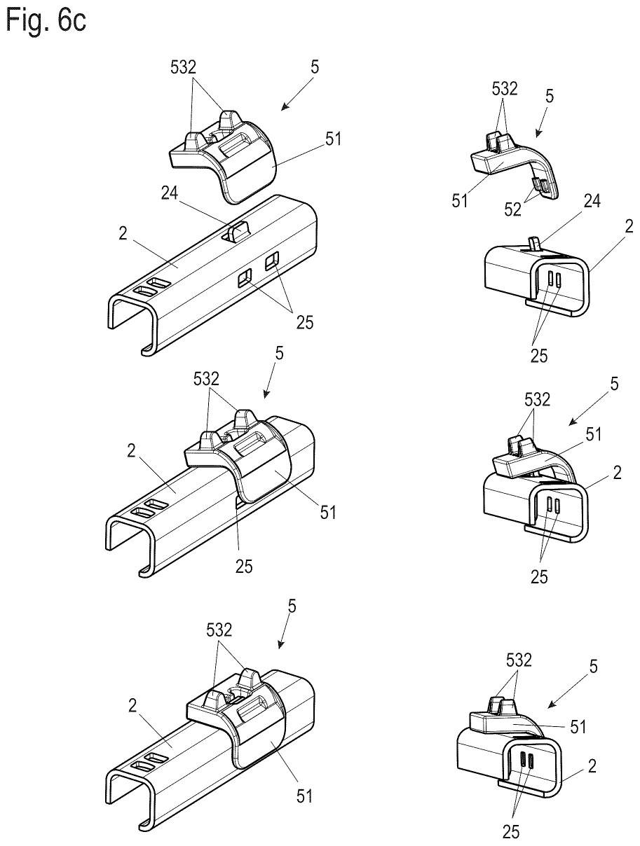

FIGS. 6a-c show a further example of an additional support element 5, which can be used in combination with the stopper 3 shown above in a pull-out guide according to the application.

FIG. 6a shows the additional support element 5 placed on a pull-out guide with the placed baking tray 6 in a sectional view looking in the pull-out direction. FIG. 6b shows the additional support element 5 separately in two isometric detailed views from different angles. Finally, FIG. 6c shows, from top to bottom, a sequence of the placement of the support element 5 on the pull-out guide in three stages. The left and right sides of the figure each show a section of a running rail 2 together with the additional support element 5 from different viewing directions.

The function and use of the additional support element 5 shown in FIGS. 6a-c correspond to the additional support element 5 shown previously in FIGS. 5a and 5b. The additional support element 5 shown previously completely embraces the running rail 2 on two sides and partially embraces it on two other sides in order to fix it radially to the running rail 2. The additional support element 5 shown in FIGS. 6a-c can be clipped onto the running rail 2 without engaging at least partially around it. It rests on only two adjacent side surfaces of the running rail 2. In order to be able to be clipped onto the running rail 2 nevertheless, it has a punched-out tab 24 on its upper side that is bent out upwards and two lateral recesses 25 on one side surface.

For mounting, the additional support element 5 is first placed on the running rail 2 at a slight angle from above so that the tab 24 engages in a receiving opening 54 formed on the additional support element 5. This is shown in FIG. 6c in the upper and middle drawings. The lateral part of the L-shaped base body 51 of the additional support element 5 is then pressed against the running rail, wherein two projections 52, which are formed on the inside of the additional support element 5, engage in the lateral recesses 25 of the running rail 2. As a result, the two inner side surfaces of the base body 51 of the additional support element 5 now lie flush against the running rail 2 and are secured in both the radial and axial directions.

As in the previous example, the additional support element 5 provides a support portion 53 on which a support, such as the baking tray 6 shown in FIG. 6a, can rest with its edge 61. In this exemplary embodiment, guide pins 532 are formed on the support portion 53 in order to fix the support laterally. Longitudinal webs (cf. longitudinal webs 531 in FIG. 5a) are not present in the present example, but could also be formed.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Cabinet rail
11 Mounting clamp
2 Running rail
21 Recess
211 Web
22 Hole
23 Stop bolt
24 Tab
25 Lateral recess
3 Stopper
31 Insertion body
32 Contact plate
33 Support portion
331 Longitudinal web
332 Guide pin
34 Base body
341 Projection
4 Stop element
41 Mounting means
42 Stop
43 Support portion
431 Longitudinal web
44 Damping cap
5 Additional support element
51 Base body
52 Projection
53 Support portion
531 Longitudinal web
532 Guide pin
54 Receiving opening
6 Baking tray
61 Edge
62 Aperture
63 Edge

1-15. (canceled)

16. A pull-out guide for a domestic appliance with microwave cooking function, the pull-out guide comprising:
a cabinet rail;
a metallic running rail movable relative to the cabinet rail and configured to support a carrier;
at least one support element for the carrier is fastened to the metallic running rail, wherein the at least one support element is at least partially made of an electrically insulating material; and
a stopper arranged in a front region of the metallic running rail as seen in a pull-out direction, wherein the stopper has a support portion configured as a support element for the carrier and oriented parallel to the pull-out direction and protruding upwardly above the metallic running rail.

17. The pull-out guide of claim 16, wherein the stopper has a contact plate for the carrier that projects forwards and upwards above the metallic running rail.

18. The pull-out guide of claim 16, wherein the support portion of the stopper has longitudinal webs on which the carrier can rest.

19. The pull-out guide of claim 16, further comprising:
an upwardly projecting guide pin for the carrier arranged in a region of the support portion of the stopper.

20. The pull-out guide of claim 16, further comprising:
a stop element mounted on the metallic running rail in a rear region as seen in the pull-out direction and having a stop for the carrier protruding upwardly above the metallic running rail.

21. The pull-out guide of claim 20, wherein the stop element has a further support portion for the carrier oriented parallel to the pull-out direction and protruding upwardly above the metallic running rail.

22. The pull-out guide of claim 20, wherein the stop is formed by a protrusion with which the stop element is placed on a stop bolt arranged on the metallic running rail.

23. The pull-out guide of claim 22, further comprising:
a damping cap, arranged on the protrusion, made of a material softer than material of the protrusion.

24. The pull-out guide of claim 16, further comprising:
at least one additional support element mounted on the metallic running rail and having a further support portion for the carrier oriented parallel to the pull-out direction and protruding upwardly above the metallic running rail.

25. The pull-out guide of claim 24, wherein the support portion of the additional support element has longitudinal webs on which the carrier can rest.

26. The pull-out guide of claim 25, further comprising:
an upwardly projecting guide pin for the carrier is arranged in the region of the further support portion of the additional support element.

27. The pull-out guide of claim 25, wherein the additional support element has a C-shaped base body that is clipped onto the metallic running rail.

28. The pull-out guide of claim 16, wherein the electrically insulating material is also thermally insulating or shock-insulating.

29. The pull-out guide of claim 16, wherein the electrically insulating material is a ceramic, a high-temperature-resistant thermoplastic, an elastomer, or a thermoset.

30. A domestic appliance with microwave cooking function, the domestic appliance comprising:
at least one pull-out guide for accommodating a food carrier, the at least one pull-out guide comprising
a cabinet rail;
a metallic running rail movable relative to the cabinet rail and configured to support a carrier;
at least one support element for the carrier is fastened to the metallic running rail, wherein the at least one support element is at least partially made of an electrically insulating material; and
a stopper arranged in a front region of the metallic running rail as seen in a pull-out direction, wherein the stopper has a support portion configured as a support element for the carrier and oriented parallel to the pull-out direction and protruding upwardly above the metallic running rail.
